(19) United States
(12) Patent Application Publication
(10) Pub. No.: US 2014/0253427 A1
(43) Pub. Date: Sep. 11, 2014

(54) GESTURE BASED COMMANDS

(71) Applicant: Qualcomm Mems Technologies, Inc., San Diego, CA (US)

(72) Inventors: Russell W. GRUHLKE, Milpitas, CA (US); Jacek Maitan, Santa Clara, CA (US)

(73) Assignee: Qualcomm Mems Technologies, Inc., San Diego, CA (US)

(21) Appl. No.: 13/786,625

(22) Filed: Mar. 6, 2013

(51) Int. Cl. G06F 3/01; G06F 3/03

(52) U.S. Cl. CPC G06F 3/017; G06F 3/0304
USPC 345/156

(57) ABSTRACT

Techniques described herein enable a computing device to detect a user hand gesture in near field using less expensive hardware by capturing enough information in coarse resolution. Furthermore, techniques described herein detect an object, such as a hand by characterizing the object without fully reconstructing the object. In one embodiment, embodiments of the invention performed by the computing device detect the number of unfurled fingers passing through the detectable region of the field of view of the detection surface of a computing device and the direction of the movement of the user's hand. The computing device may determine a user command in response to detecting the user gesture and provide feedback to the user.

### BACKGROUND

1. Technical Field

Aspects of the disclosure relate to computing technologies. In particular, aspects of the disclosure relate to mobile computing device technologies, such as systems, methods, apparatuses, and computer-readable media that determine a user hand gesture.

2. Relevant Background

Interactions with many modern mobile devices are accomplished using human interfaces, such as touch screens coupled to mobile devices. One of the challenges is to appropriately accommodate human interfaces for small appliance, such as mobile phones, watches or tablets and make them usable and functional. Traditionally, the user is restricted to carefully touching small areas of the screen, use a stylus or another attachment to increase the touch precision. This mode of human interface operation is applied across a full spectrum of devices that are available today. None of these solutions effectively address the needs of even smaller devices and often require a level of dexterity beyond the ability of many users, especially seniors. Additionally, space constraints and demand for high functionality make it difficult to create an easy to follow touch gesture sequence.

### SUMMARY

According to one or more aspects of the disclosure, techniques described herein enable a computing device to detect a hand gesture in near field using less expensive hardware by capturing enough information in coarse resolution. Furthermore, techniques described herein detect an object, such as a hand, by characterizing the object without fully reconstructing an image of the object. In one embodiment, embodiments of the invention performed by the computing device detect the number of unfurled fingers passing through the detectable region of the field of view of the detection surface of a computing device and the direction of the movement of the user's hand. The computing device may determine a user command in response to detecting the user hand gesture and provide feedback to the user.

An exemplary method for determining a user hand gesture may include determining if a user's hand is within a detectable region of the field of view of a detection surface coupled to a computing device, detecting a sequence of one or more hand features associated with the user hand, detecting a direction of movement of the user hand and determining the user hand gesture, in response to detecting the sequences of one or more hand features and the direction of the movement of the user's hand. In one implementation of the method, the detection of the user hand gesture begins when the hand enters the detectable region of the field of view and the detection of the user hand gesture completes when the hand exits the detectable region of the field of view. The detectable region of the field of view may be a near field mode.

In one aspect, determining the user hand gesture may further comprise accumulating the information associated with the one or more hand features. The one or more hand features may be fingers or finger tips and accumulating the information associated with the one or more hand features may involve counting the number of unfurled fingers or finger tips. In one implementation of the method performing embodiments of the invention, detecting the direction of the movement of the user's hand is one of left to right, right to left, top to bottom, bottom to top, away from the detection surface and towards the detection surface.

In an exemplary implementation of the method, the one or more hand features are detected using an electro-optic technology that measures and interprets intensity of the light that is bended by a transparent panel, wherein the transparent panel is part of the detection surface. In another exemplary implementation of the method, the one or more hand features are detected using one of capacitive sensors and ultrasound proximity sensors. For detecting a sequence of one or more hand features, in one implementation it is based on detecting characteristics of the hand from shadows casting from the hand on the detection surface. In another implementation, detecting a sequence of one or more hand features is based on detecting characteristics of the hand by emitting light from the computing device and away from the detection surface from the detection surface and detecting reflected back light from the hand onto the detection surface. The exemplary method may further include determining a user command in response to detecting the user hand gesture and providing visual and/or auditory feedback to a user in response to determining the user command.

An exemplary computer device for determining a user hand gesture may include a plurality of sensors configured to receive light signals and a processor configured for determining if a user's hand is within a detectable region of the field of view of a detection surface coupled to a computing device, detecting a sequence of one or more hand feature associated with the user hand, detecting a direction of movement of the user hand and determining the user hand gesture, in response to detecting the sequences of one or more hand feature and the direction of the movement of the user's hand. In one implementation of the computer device, the detection of the user hand gesture begins when the hand enters the detectable region of the field of view and the detection of the user hand gesture completes when the hand exits the detectable region of the field of view. The detectable region of the field of view may be a near field mode.

In one aspect, determining the user hand gesture may further comprise accumulating, by the processor, the information associated with the one or more hand features. The one or more hand features may be fingers or finger tips and accumulating the information associated with the one or more hand features may involve counting the number of unfurled fingers or finger tips. In one implementation, detecting the direction of the movement of the user's hand may be one of left to right, right to left, top to bottom, bottom to top, away from the detection surface and towards the detection surface.

In an exemplary implementation of the computer device, the one or more hand features are detected using an electro-optic technology that measures and interprets intensity of the light that is bended by a transparent panel, wherein the transparent panel is part of the detection surface. In another implementation of the computer device, the one or more hand features are detected using one of capacitive sensors and ultrasound proximity sensors. For detecting a sequence of one or more hand features, in one implementation it is based on detecting characteristics of the hand from shadows casting from the hand on the detection surface. In another implementation, detecting a sequence of one or more hand features is based on detecting characteristics of the hand by emitting light from the computing device and away from the detection surface from the detection surface and detecting reflected back light from the hand onto the detection surface. The exemplary computer device may further include determining a user command in response to detecting the user hand gesture and providing visual and/or auditory feedback to a user in response to determining the user command.

An exemplary non-transitory computer readable storage medium, wherein the non-transitory computer readable storage medium may include instructions executable by a processor for determining a user hand gesture may include determining if a user's hand is within a detectable region of the field of view of a detection surface coupled to a computing device, detecting a sequence of one or more hand feature associated with the user hand, detecting a direction of movement of the user hand and determining the user hand gesture, in response to detecting the sequences of one or more hand feature and the direction of the movement of the user's hand. In one implementation of the non-transitory computer readable storage medium, the detection of the user hand gesture begins when the hand enters the detectable region of the field of view and the detection of the user hand gesture completes when the hand exits the detectable region of the field of view. The detectable region of the field of view may be a near field mode.

In one aspect, determining the user hand gesture may further comprise accumulating the information associated with the one or more hand features. The one or more hand features may be fingers or finger tips and accumulating the information associated with the one or more hand features may involve counting the number of unfurled fingers or finger tips. In one implementation, detecting the direction of the movement of the user's hand is one of left to right, right to left, top to bottom, bottom to top, away from the detection surface and towards the detection surface.

In an exemplary implementation of the non-transitory computer readable storage medium, the one or more hand features are detected using an electro-optic technology that measures and interprets intensity of the light that is bended by a transparent panel, wherein the transparent panel is part of the detection surface. In another implementation, the one or more hand features are detected using one of capacitive sensors and ultrasound proximity sensors. For detecting a sequence of one or more hand features, in one implementation it is based on detecting characteristics of the hand from shadows casting from the hand on the detection surface. In another implementation, detecting a sequence of one or more hand features is based on detecting characteristics of the hand by emitting light from the computing device and away from the detection surface from the detection surface and detecting reflected back light from the hand onto the detection surface. The exemplary non-transitory computer readable storage medium may further include determining a user command in response to detecting the user hand gesture and providing visual and/or auditory feedback to a user in response to determining the user command.

An exemplary apparatus for determining a user hand gesture may include a means for determining if a user's hand is within a detectable region of the field of view of a detection surface coupled to a computing device, a means for detecting a sequence of one or more hand feature associated with the user hand, a means for detecting a direction of movement of the user hand and determining the user hand gesture, in response to detecting the sequences of one or more hand feature and the direction of the movement of the user's hand. In one implementation, the detection of the user hand gesture begins when the hand enters the detectable region of the field of view and the detection of the user hand gesture completes when the hand exits the detectable region of the field of view. The detectable region of the field of view may be a near field mode.

In one aspect, determining the user hand gesture may further comprises a means for accumulating the information associated with the one or more hand features. The one or more hand features may be fingers or finger tips and accumulating the information associated with the one or more hand features may involve a means for counting the number of unfurled fingers or finger tips. In one implementation, detecting the direction of the movement of the user's hand is one of left to right, right to left, top to bottom, bottom to top, away from the detection surface and towards the detection surface.

In one implementation of the exemplary apparatus, the one or more hand features are detected using an electro-optic technology that measures and interprets intensity of the light that is bended by a transparent panel, wherein the transparent panel is part of the detection surface. In another implementation, the one or more hand features are detected using one of capacitive sensors and ultrasound proximity sensors. For detecting a sequence of one or more hand features, in one implementation it is based on a means for detecting characteristics of the hand from shadows casting from the hand on the detection surface. In another implementation, detecting a sequence of one or more hand features is based on a means for detecting characteristics of the hand by emitting light from the computing device and away from the detection surface from the detection surface and detecting reflected back light from the hand onto the detection surface. The exemplary apparatus may further include determining a user command in response to detecting the user hand gesture and providing visual and/or auditory feedback to a user in response to determining the user command.

The foregoing has outlined rather broadly features and technical advantages of examples in order that the detailed description that follows can be better understood. Additional features and advantages will be described hereinafter. The conception and specific examples disclosed can be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

Aspects of the disclosure are illustrated by way of example. The following description is provided with reference to the drawings, where like reference numerals are used to refer to like elements throughout. While various details of one or more techniques are described herein, other techniques are also possible. In some instances, well-known structures and devices are shown in block diagram form in order to facilitate describing various techniques.

A further understanding of the nature and advantages of examples provided by the disclosure can be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, the reference numeral refers to all such similar components.

FIG. 1 illustrates an example device that may implement one or more aspects of the disclosure

FIG. 2 is a flow diagram illustrating a method for performing embodiments of the invention according to one or more illustrative aspects of the disclosure.

FIG. 3 depicts a block diagram, showing exemplary components and modules for performing methods provided by embodiments of the invention.

FIG. 4 illustrates an exemplary configuration with a detection surface and a detection region.

FIG. 5 is a figure illustrating a detection surface using an exemplary technology in implementing embodiments of the invention.

FIG. 6 illustrates an exemplary implementation of the detection surface and detection region according to embodiments of the invention.

FIGS. 7A, 7B, 7C, 7D and 7E illustrate a progression of a hand over the detection surface from one direction to another within the detection region for the computing device.

FIG. 8 illustrates the dip in intensity and phase difference between four signals.

FIG. 9 illustrates basic finger counting using one hand, according to embodiments of the invention.

FIG. 10 illustrates an exemplary computing device incorporating parts of the device employed in practicing embodiments of the invention.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Current gesture technology optimally works at either far field or by directly touching the detection surface. For instance, in far field, such as a user interacting with a TV set-top box from his/her couch, the device may use one or more cameras mounted on the device or use light sensing elements in the display pixels to take one or more high resolution pictures, reconstruct the image and identify the gesture from the image. Such a method may require expensive hardware to capture high resolution images and process the images near real-time. Furthermore, this method may be compute expensive, requiring power hungry components that may be acceptable for a TV set-top box, but not for a mobile device.

In other implementations, the device may provide a touch screen interface to the user to interact with the device, limiting the user's interaction with the device to directly interacting with the detection surface. The user is also restricted to carefully touch small areas of the screen or use stylus or other attachments to increase the touch precision.

The optimal region for operation for most mobile devices is in near field. However, current gesture recognition using far field and touch screen technologies does not sufficiently service the users by allowing them interaction with the device at near field. For instance, for interacting with a watch or a smart phone the user may desire to interact with the device in the region of operation between the user and the device. However, for such interaction, in near field, using current technology for recognizing gestures is difficult and compute intensive. Capturing a swiping gesture in the near field is equivalent to capturing objects with high angular velocity and requires higher frame rates as compared to capturing the same gesture at the distance. This explains at least partially why, in near field, to capture gestures by the user requires very rapid succession of frames as opposed to in the far field, making it difficult for the device to detect the gesture, especially using similar techniques currently used for far field. This makes data image capture and characterization difficult and expensive for a traditional system, such as a camera based system currently used for far field gesture detection.

Another difficulty in detecting a gesture at near field is that the field of view for most sensing devices, such as a camera, is very limited in near field and expands as the distance from the device increases. Since, the field of view is limited in near field it is difficult and impractical in many situations to acquire the entire gesture at the same instance.

Embodiments of the invention address these and other problems. In one embodiment, techniques described enable the computing device 100 to detect a hand gesture in near field, using less expensive hardware, by capturing enough information in coarse resolution. Furthermore, techniques described herein detect an object, such as a hand by characterizing the object without fully reconstructing the object. Although, the problems described relate to detection of gestures in near field, similar techniques described herein may be used to detect gestures at far field.

In one embodiment, embodiments of the invention performed by the computing device 100 detect the number of unfurled fingers passing through the detectable region of the field of view of the detection surface and the direction of the movement of the user's hand. The computing device 100 determines a user hand gesture in response to detecting the unfurled fingers and the direction of movement of the user's hand.

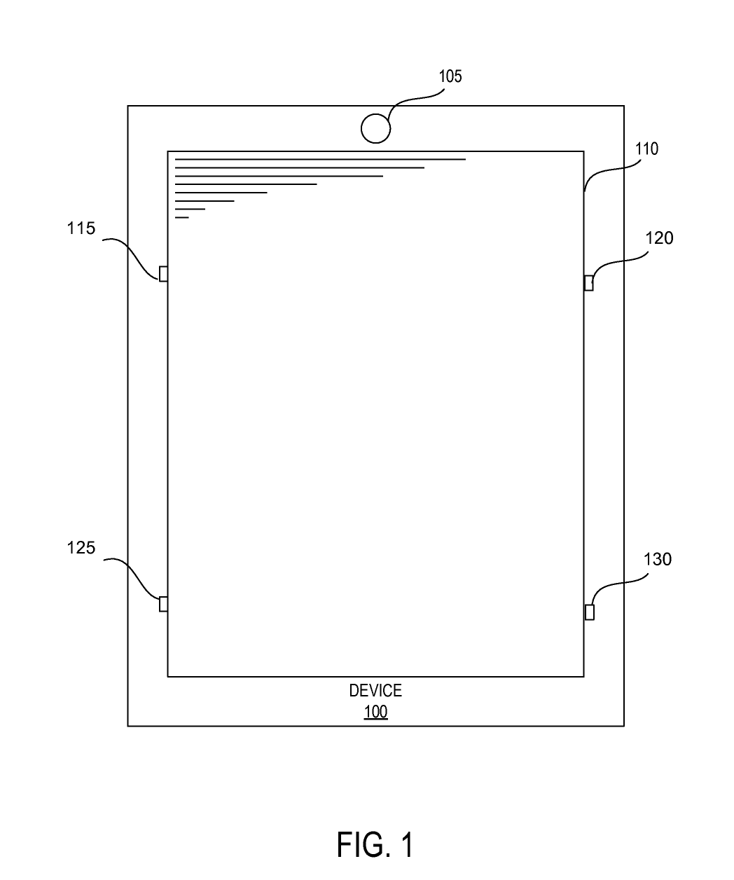

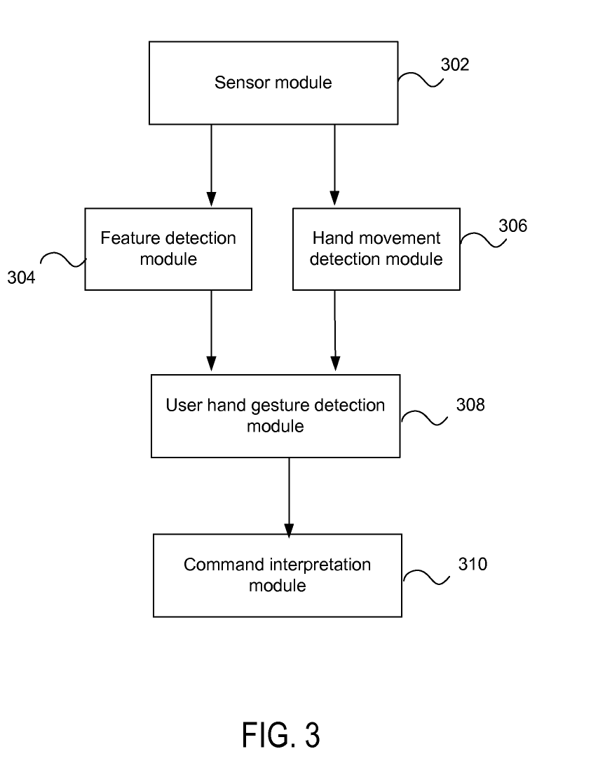

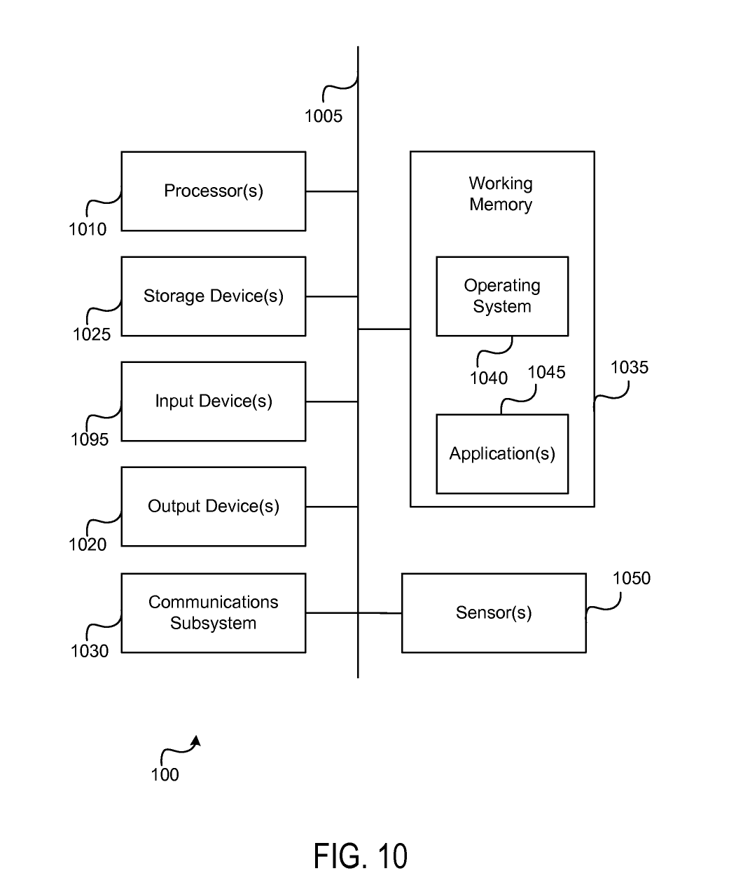

FIG. 1 illustrates an example computing device 100 that may implement one or more aspects of the disclosure. FIG. 10 describes components that may be fully or partially embodied within the computing device 100 described in FIG. 1. Furthermore, FIG. 3, may describe components or modules, implemented in hardware, software, firmware or any combination thereof that may be implemented by the computing device 100. For example, computing device 100 may be a personal computer, set-top box, electronic gaming console device, laptop computer, smart phone, tablet computer, personal digital assistant, or other mobile device that is equipped with one or more sensors that allow computing device 100 to capture motion and/or other sensed conditions as a form of user input. For instance, computing device 100 may be equipped with, be communicatively coupled to, and/or otherwise include one or more cameras, microphones, proximity sensors, photo-sensors, gyroscopes, accelerometers, pressure sensors, grip sensors, touch screens, and/or other sensors. In addition to including one or more sensors, computing device 100 also may include one or more processors, memory units, and/or other hardware components, as described in greater detail below.

In one or more arrangements, computing device 100 may use any and/or all of these sensors alone or in combination to recognize gestures performed by one or more users of the device. For example, computing device 100 may use one or more photo sensors, such as camera 105, to capture hand movements performed by a user, such as a hand wave or swipe motion, among other possible movements. While these sample movements, which may alone be considered gestures and/or may be combined with other movements or actions to form more complex gestures, are described here as examples, any other sort of motion, movement, action, or other sensor-captured user input may likewise be received as gesture input and/or be recognized as a gesture by a computing device 100 implementing one or more aspects of the disclosure, such as computing device 100.

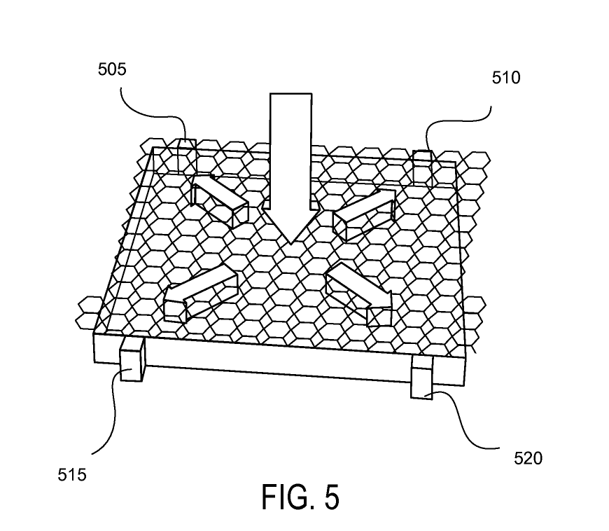

In another non-limiting example, computing device 100 may use a plurality of photo-detectors (e.g., 115, 120, 125 and 130) arranged at the periphery of the device screen 110. In one embodiment, the device screen 110 may also serve a second purpose of acting as a detection surface and transmitting signals to the periphery sensors. One or more hand features may be detected using an electro-optic technology that measures and interprets intensity of the light that is bended by a transparent panel, wherein the transparent panel is either integrated into the device screen 110 or is overlaid on top of the device screen 110. FIGS. 5, 6, 7 and 8, describe these exemplary techniques for performing embodiments of the invention in more detail.

As used herein, a “gesture” is intended to refer to a form of non-verbal communication made with part of a human body, such as a hand, and is contrasted with verbal communication such as speech. For instance, a gesture may be defined by a movement, change or transformation between a first position, pose, or expression and a second pose, position, or expression.

A body part may make a gesture (or “gesticulate”) by changing its position (i.e. a waving motion), or the body part may gesticulate without changing its position (i.e. by making a clenched first gesture). In some arrangements, hand and arm gestures may be used to affect the control of functionality via camera or photo sensor input, while in other arrangements, other types of gestures may also be used. Additionally or alternatively, hands may be moved in making and/or detecting one or more gestures. For example, some gestures may be performed by moving one or more hands.

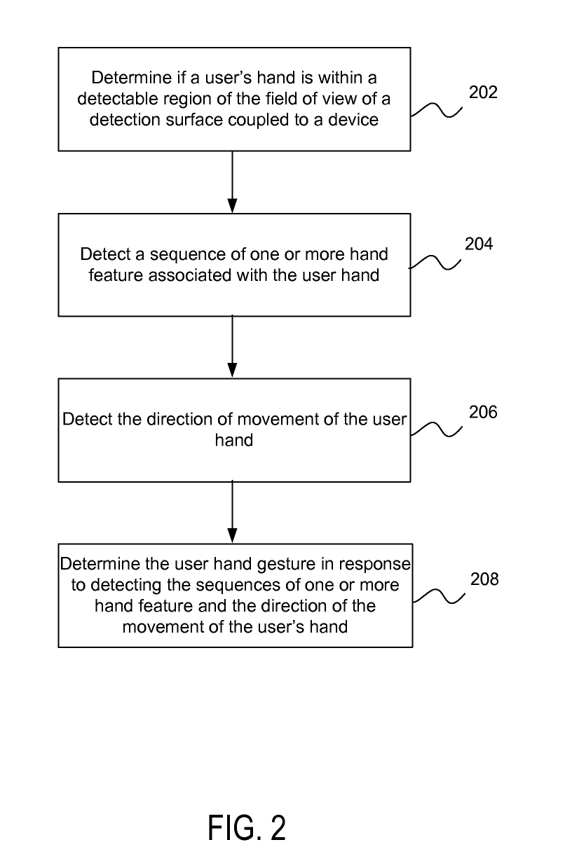

FIG. 2 is a flow diagram illustrating a method for performing embodiments of the invention according to one or more illustrative aspects of the disclosure. According to one or more aspects, any and/or all of the methods and/or method steps described herein may be implemented by and/or in a computing device 100, such as the computing device 100 and/or the device described in greater detail in FIG. 10, for instance. In one embodiment, one or more of the method steps described below with respect to FIG. 2 are implemented by a processor of the computing device 100, such as the processor 1010 or another processor. Modules and components discussed in FIG. 3, may also be implemented as components of the computing device 100 and may be used in performing embodiments of the invention as discussed in FIG. 2. Additionally or alternatively, any and/or all of the methods and/or method steps described herein may be implemented in computer-readable instructions, such as computer-readable instructions stored on a computer-readable medium such as the memory 1035, storage 1025 or another computer readable medium.

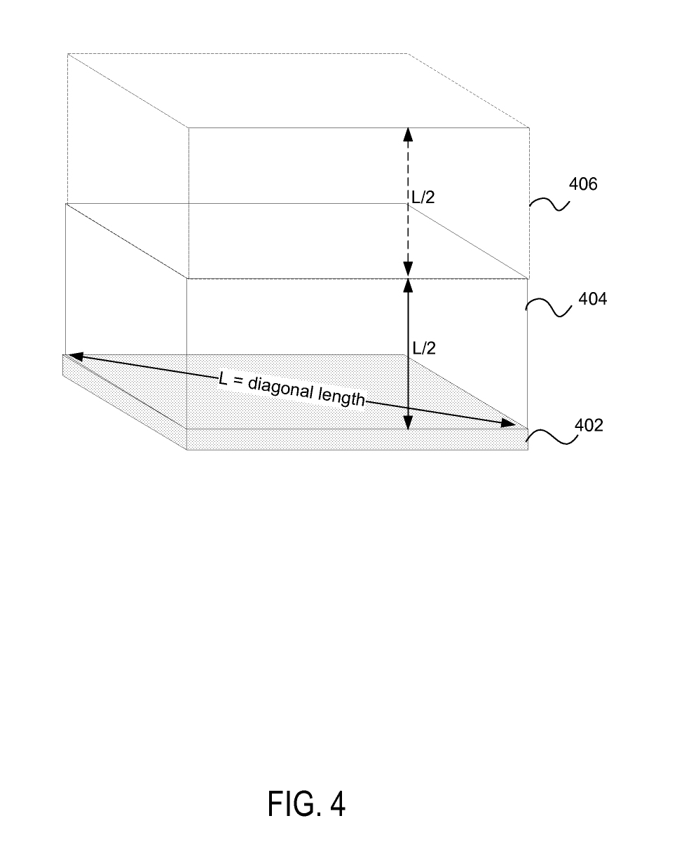

At step 202, components of the computing device 100, such as the sensor module 302, detect if the user's hand is within a detectable region of the field of view of a detection surface coupled to the computing device 100. In one embodiment, the user's hand is detected by detecting a change in light or shadows incident on the detection surface using the plurality of photo-detectors (115, 120, 125, and 130). In one implementation, the change in the intensity of the light or shadow may determine the distance of the user's hand from the detection surface. In one embodiment, the detectable region of the field of view is referred to as a near field. The computing device 100 that is configured to detect in the near field is referred to as operating in near field mode. In one implementation, the near field mode may be pre-defined for a device. An exemplary near field region, as shown in FIG. 4, may include the region starting from the detection surface and extending outward to between one half the diagonal length of the detection surface to the full diagonal length of the detection surface. In another implementation, the detection region for the computing device 100 operating in near field mode is configured during a provisioning phase of the device. In yet another implementation, the detection region for the computing device 100 operating in near field mode is auto-configured by the computing device 100 based on the environmental conditions, such as lighting conditions.

At step 204, components of the computing device 100, such as the feature detection module 304, detects a sequence of one or more hand features associated with the user hand. In one implementation, the sequence of one or more hand features may include one or more fingers or finger tips. Detecting the one or more hand features in sequence may refer to detecting the one or more hand features one after the other in time. This may be advantageous, since in many small devices with a small detection surface, it may not be possible to detect all the features needed to determine the user hand gesture in one instance since all the features may not fit in the field of view of the detection surface at the same time. In one implementation, the hand features are detected using an electro-optic technology that measures and interprets intensity of the light that is bended by a transparent panel, wherein the transparent panel is part of the detection surface. In one aspect, detecting a sequence of one or more hand features is based on detecting characteristics of the hand using shadows casting from the hand onto the detection surface. In another aspect, detecting a sequence of one or more hand features is based on detecting characteristics of the hand by emitting light from the detection surface and detecting reflected back light from the hand onto the detection surface. FIGS. 5, 6, 7 and 8 discuss in more details techniques for detecting using the electro-optic technology discussed above. In another implementation, the one or more hand features may also be detected using one of capacitive sensors, ultrasound proximity sensors or any other suitable technology.

At step 206, components of the computing device 100, such as the hand movement detection module 306, detects a direction of movement of the user's hand. Components of the computing device 100 may use techniques discussed with reference to step 204, such as using electro-optic technology, capacitive sensor technology, ultrasound proximity sensor technology or any other suitable means for detecting the direction of movement of the user's hand. In one embodiment, the direction of the movement of the user's hand is one of left to right, right to left, top to bottom, bottom to top, diagonally in each direction and away from the detection surface or towards the detection surface.

Although, not shown in FIG. 2, steps 204 and 206 may be performed in reverse order, i.e. detecting the direction of the movement of the user's hand may be performed before detecting a sequence of one or more hand features associated with the user's hand. Furthermore, in yet another implementation, steps 204 and 206 may be performed concurrently.

At step 208, components of the computing device 100, such as the user hand gesture detection module 308, determines the user hand gesture in response to detecting the sequence of one or more hand feature and the direction of the movement of the user's hand. The user hand gesture detection module 308, at step 208 may also map a new gesture to a known command or sequence of commands. In one implementation, this may result in simply mapping a new gesture to an old gesture or sequence of gestures.

In one implementation, the computing device 100 determines the user hand gesture by accumulating the information associated with the one or more hand features. As discussed before, the one or more hand features may be fingers or finger tips and accumulating the information associated with the one or more hand features may comprise counting the number of unfurled fingers or finger tips and detecting the user hand gesture. The computing device 100 may determine a user command in response to detecting a user hand gesture. The computing device 100 may provide visual and/or auditory feedback to the user in response to determining the user command. Feedback mechanism may be any mechanism that the system provides to aid the user in the execution of application or in general use of system features. For instance, components of the computing device 100 may display a visual indication on the display device that the computing device 100 is in a calling mode by displaying a visual representation of a rotary phone.

It should be appreciated that the specific steps illustrated in FIG. 2 provide a particular method of switching between modes of operation, according to an embodiment of the present invention. For instance, detecting a user hand gesture may cause the device to detect a user command that switches the device from one mode of operation to another, such as from inactive to calling. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 2 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the process.

The above described method may be advantageous in implementing low powered solutions on mobile computing devices 100 where battery life, power consumption, and low design complexity are important considerations. For example, in a confined space environment, using several photo detectors or other high speed sensors make it possible and economical to detect hand features and accumulate information about those hand features, such as counting fingers. Implementing embodiments of the invention may be advantageous, since power efficient photo detectors and the reduced processing complexity may save power.

FIG. 3 depicts a block diagram, showing exemplary components and modules for performing methods provided by embodiments of the invention. Computing device 100 discussed in FIG. 1 and FIG. 10, may represent some of the components of the computing device 100 used for performing the embodiments of the invention described in FIG. 3. The components and modules discussed in FIG. 3 may be implemented in hardware, software, firmware or any combination thereof.

In one implementation, effective algorithms embodied by the modules may be run on a small processor (not shown) that signals the recognized gesture (finger count) and gesture movement direction to the main processor 1010 through one of the existing communication ports such as Serial Peripheral Interface (SPI) or Inter-Integrated Circuit (I2C). In one implementation, the solution may form a self-contained module that may be easily added to any computing device 100 that has any suitable technology able to distinguish finger movements over the surface may be included.

The sensor module 302 may detect one or more analog, optical or electrical rays or pulses in determining that the user's hand is within a detectable region of the field of view of a detection surface coupled to the computing device 100. In one embodiment, the sensor module 302 may convert the signal to digital signal using an analog to digital converter (not shown). In one embodiment, the sensor module 302 receives signals from photo sensors or micro-cameras placed at the periphery of a flat and transparent optical layer added to the display which redirects a sample of the incident light to the its edges.

In some embodiments, converting analog information to digital information may be advantageous, since this allows for easier implementations using standard low cost digital components. However, in some implementations, converting analog information to the digital may domain may require longer processing time and consumer more energy by adding additional steps. Furthermore, digital components are not designed to be event-driven further contributing to higher consumption of power in some instances.

In an alternative embodiment, an analog system modeled after biological system may be incorporated near or at the light collection pixels. These systems may not require an explicit clocking system for controlling the flow of data. This may result in an event driven implementation. Analog processing involved in vision analysis can be performed by converting light intensity into pulses; this method is similar to signal propagation along neural axons that features distinctive pulses. Activities expressed as pulse trains can be used to coordinate neighboring detectors resulting in detecting and labeling an event. In one implementation, this method may be implemented using a silicon based neuromorphic implementation.

Such a system, while processing input in the analog domain, may detect a direction of swipe by finding and tracking changes of light intensity in the pixels along particular edge. Detecting a sequence of correlated threshold crossing along the edge may be a reliable indicator and may be used to detect the edge of the gesturing hand or parts of the hand. In this exemplary approach, a tip of the finger is an area next to the line of pixels with correlated light changes, but with no observed light intensity changes.

The process of detecting light intensity changes may incorporate conversion of light into a train of pulses in a manner that may be similar to a well-known Pulse Width Modulation or Pulse Frequency Modulation encoding of signal. Relative density of pulses can be used to detect a signal peak. These changes can also be tracked. Occurrences of peaks can be correlated to identify their relative position within aperture. No explicit analog to digital conversion may be needed and processing may be in the analog domain resulting in detecting edge transition. This scheme reduces the process of finger detection to track and count light changes.

Analog processing can be used independently or collectively with digital processing. In such an event driven implementation, a grouping of sensors, resulting in a “group” decision, determines that a gesture includes passing edge. Based on this a group of detectors, the area of aperture next to the moving edge may be labeled as a fingertip. A graph of elements, such as fingertips, edges can be bundled together to detect a hand. Next, a digital processor may be involved to identify the number of fingers involved.

In another embodiment, the sensor module 302 may be implemented using an electro-optic technology that measures and interprets intensity of the light that is bent by a glass panel, wherein the glass panel is part of the detection surface. In one aspect the hand features and the movement of the hand are detected by detecting shadows casting or falling from the hand onto the detection surface. In another aspect, detecting a sequence of one or more hand features is based on detecting characteristics of the hand by emitting light from the detection surface and detecting reflected back light from the hand onto the detection surface. In yet another implementation, the sensor module may be implemented using capacitive sensors, ultrasound proximity sensors or any other suitable technology for detecting hand features and direction of movement of the hand.

The feature detection module 304 may receive the digitized signal from the sensor module and detect a sequence of one or more hand features associated with the user hand. In one implementation, the feature detection module 304 may also accumulate the information associated with the one or more hand features. In one embodiment, the one or more hand features are fingers or finger tips and accumulating the information associated with the one or more hand features is counting the number of unfurled fingers or finger tips. Accumulating the information about the hand, sequentially, may be advantageous where the field of view is not large enough to accommodate all the features of the hand that are needed to recognize a particular command. For instance, as the hand passes through the detection region of a device, only one finger or a part of a finger may be within the field of view of the device sensors. Information about one finger from the plurality of fingers by itself may not be enough to construct the user command. Therefore, in this example, accumulating the information allows the components of the computing device to gather information about all five fingers (furled or unfurled) of the hand for interpreting the command.

The hand movement detection module 306 may receive the digitized signal from the sensor module and detect a direction of movement of the user hand. The movement of the user's hand is one of left to right, right to left, top to bottom, bottom to top, away from the detection surface and towards the detection surface. Additionally, in one embodiment, the movement of the hand may also be inferred by accumulating information about the movement of a particular feature through the field of view of the device. For instance, in one embodiment, the hand movement detection module may track the thumb finger or any other feature through, over time, to infer the movement of the hand. In one implementation, the functions of the feature detection module 304 and the hand movement detection module 306 may be performed using the same hardware component or module.

The user hand gesture detection module 308 may determine the user hand gesture in response to detecting the sequence(s) of one or more hand features and the direction of the movement of the user's hand. In one embodiment, the user hand gesture detection module starts detecting the user hand gesture when the hand enters the detectable region of the field of view and the user hand detection completes when the hand exits the detectable region of the field of view. The command interpretation module 310 may determine the user command in response to detecting one or more user hand gesture. In one implementation, the command interpretation module 310 may compare the one or more user hand gestures to values stored in a look up table to determine a user command.

FIG. 4 illustrates an exemplary configuration with a detection surface and a detection region for near field detection. The detection surface 402 has a diagonal length of L. In one embodiment, the height of the detection region for detection of a gesture in near field is directly proportional to the diagonal length of the detection surface. In one embodiment, the detection region includes the detection surface. In another embodiment, the detection region does not include the detection surface and the detection surface only facilitates the detection of the gesture by propagating the light rays or pulses to the photo-sensors. For instance, in one implementation, the detection region may include the region starting from the detection surface and extending outward to between one-half the diagonal length (404) of the detection surface to the full diagonal length of the detection surface (406). In another implementation, the detection region for the computing device 100 operating in near field mode is configured during a provisioning phase of the device using a pre-determined value such as 4 inches from the display or any other distance appropriate for reliably detecting a hand gesture. In yet another implementation, the detection region for the computing device 100 operating in near field mode is auto-configured by the computing device 100 based on the environmental conditions, such as lighting conditions and the change in the sensing capabilities of the sensor over time.

FIG. 5 is a figure illustrating a detection surface using an exemplary technology in implementing embodiments of the invention. FIG. 5 illustrates an electro-optic technology that measures and interprets intensity of the light that is bended by specially formed optical layer. The optical layer may be a flat and transparent panel made from glass or any other suitable material in one embodiment. In one embodiment, the transparent panel is integrated into the display device 110, from FIG. 1. Micro-cameras or photo sensors/detectors may be placed at the periphery and used to collect the light samples and then recover scene information about the objects in the detection region. In one embodiment, components of the computing device 100 may measure a shadow casted by parts of the hand in detecting a gesture. FIG. 5 shows a non-limiting exemplary configuration with 4 photo detectors (505, 510, 515 and 520) that measures the shadow of the hands passed over the field of view. Another advantage of this embodiment of the invention is that fingers do not occlude each other, since the system samples light normally incident to the detection surface and the interaction space is not limited to the surface, enabling a three dimensional user interface for position and gesture sensing.

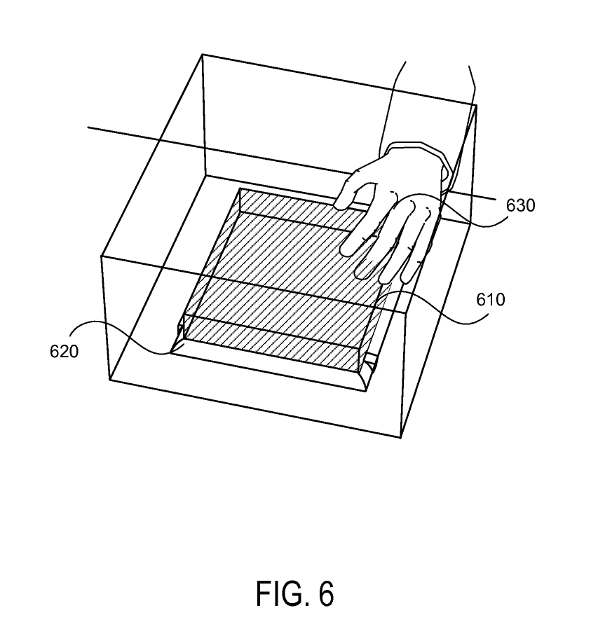

FIG. 6 illustrates an exemplary implementation of the detection surface and detection region according to one embodiment of the invention. Due to the nature of physics involved in the process, the field of view is limited to the region just above the surface and may be delimited by the edges of the detection surface 620 forming the system aperture, as shown in FIG. 6, forming the detection region 610. As the hand 630 and consequently the fingers pass over the aperture and are inside detection region, shadows of the fingers modulate light intensity that is measured by photo detectors, as shown in FIG. 5. The photo detectors further away may see less light as compared to the one near the hand 630. This creates the phase differentiation allowing for detection of the direction of the movement of the hand.

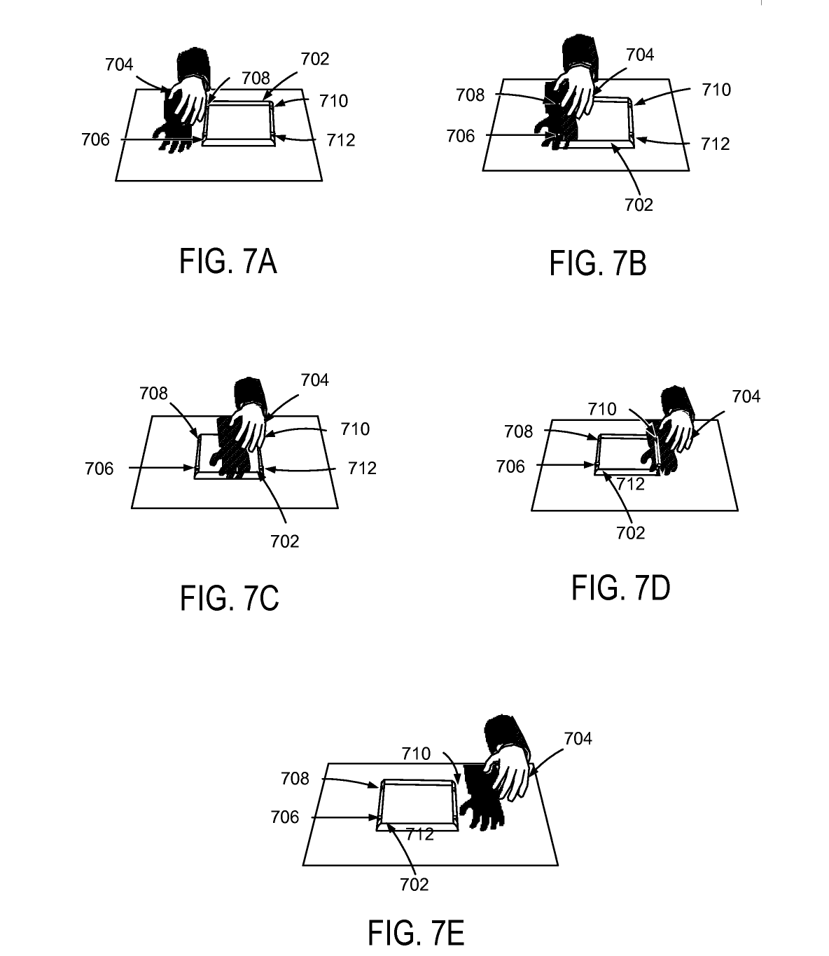

FIGS. 7A, 7B, 7C, 7D and 7E illustrate a progression of a hand 704 over the detection surface from one direction to another within the detection region 702 for the computing device. The computing device 100 may not be able to sense the entire gesture at any particular time due to the limited size of the detection region. Therefore, according to embodiments of the invention, the computing device 100 may accumulate information, as shown in FIGS. 7A, 7B, 7C, 7D and 7E. Accumulating the information about the hand 704, sequentially, may be advantageous where the field of view is not large enough to accommodate all the features of the hand 704 that are needed to recognize a particular command. For instance, as the hand 704 passes through the detection region 702 of a device, only one finger or a part of a finger may be within the field of view of the device sensors (706, 708, 710 and 712). Information about one finger from the plurality of fingers by itself may not be enough to construct the user command. Therefore, in this example, accumulating the information allows the components of the computing device to gather information about all five fingers (furled or unfurled) of the hand 704 for detecting the user hand gesture and subsequently interpreting the command.

In one embodiment, the computing device starts detecting the user hand gesture when the hand 704 enters the detectable region 702 of the field of view and the detection of the user hand gesture completes when the hand 704 exits the detectable region 702 of the field of view. FIG. 7A marks the beginning of the detection of the user hand gesture, whereas FIG. 7E marks the end of the detection of the user hand gesture.

As shown in FIGS. 7A-E, when the hand 704 or finger passes directly above this system, then some of the ambient light is blocked from reaching the photodiodes. As the hand 704 moves over the detection surface, the ambient light not obscured by hand 704 passes through the front light and strikes the detection surface. This ambient light is trapped and guided within the light guide. Some of this light propagates to detectors (photo diodes) on the edges of the light guide (see FIG. 5). Ambient light is then collected by the optical subsystem. The comparison of the measured light intensity of the ambient light to pre-determined thresholds or relative change in the light intensity results in the effective detection of shadows. Furthermore, this shadow detection is most effective when the blocking object is near or hovering over the device. This characteristic enables near field detection; i.e. an object and its motion can be sensed when that object is in close proximity to the device above the surface of the device, within the detection region.

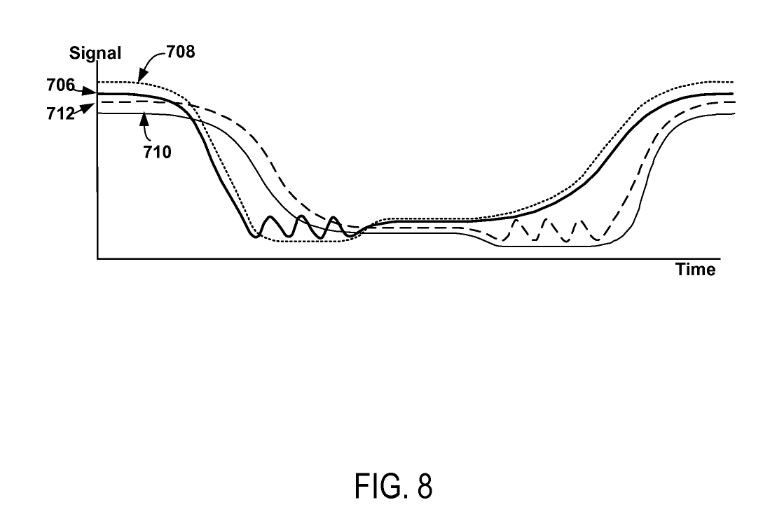

FIG. 8 illustrates an example of the dip in intensity and phase difference between four signals for the gesture, illustrated in FIGS. 7A-E, that enables embodiments of the invention, such as detection of the user hand gesture. In FIG. 7 and FIG. 8, the four signals are detected using four photo detectors (706, 708, 710 and 712), however, other sensors may also be used for detecting the signals. Furthermore, the number of sensors used in detecting the hand gesture may use more or less than four sensors and are not limited in any manner by the example of FIG. 8. In FIG. 8, shadows of fingers may be easily recognized as a sequence of dips illustrated in the signals from 706 and 712. In one implementation, sensors are geometrically separated by a medium that attenuates the light. Rapid decline of the amount of light collected by a sensor closer to the shadow results in a separation curve reflecting the impact of the moving shadow on the light collected by the photo sensors. In case of computing devices 100 with a small field of view, pairs of sensors on opposite sides along the trajectory of the moving shadow may experience the same change of the measured light intensity, but slightly shifted in time in the event of shadow entering the field of view followed by rapid increase when the shadow leaves the field of view. Visually recognizable dips in the measured light intensity may serve as clear indication of the event in progress.

In one implementation, finger counting may be achieved by monitoring of the detectable region over the detection surface. In one embodiment, the detection surface is the display device 110 for the computing device 100 that may also be used for providing graphical feedback to the user regarding the detection of the user command. The computing device 100 may be configured to provide other forms of feedback such as auditory, visual cues, such as LED blinking, or vibration. Feedback mechanism may be any mechanism that the system provides to aid the user in the execution of application or in general use of system features. One of the objectives of providing feedback may be to confirm the correctness, signal error or provide clues for further interaction. Proper feedback may be desirable to assure that a gesture sequence is correctly interpreted. For example, in one embodiment, the computing device 100 may show images corresponding to the gestures in a feedback loop.

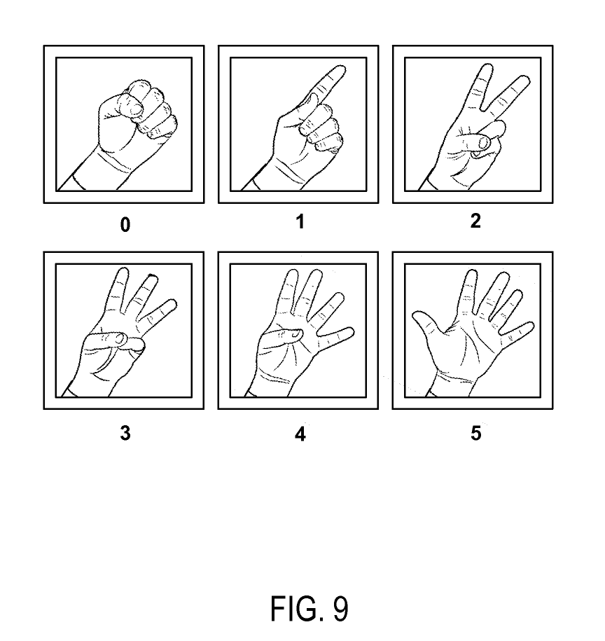

FIG. 9 illustrates basic finger counting using one hand, according to embodiments of the invention. In an exemplary embodiment, a set of gesture symbols may be defined as shown in Table 1. The computing device 100 may detect these gestures using embodiments of the invention by detecting direction (L-left, R-right, U-up, D-down) and detecting the finger count (0, 1, 2, 3, 4, 5). Table 1 shows an example construction of the gesture semantics when using direction and finger count. In one exemplary notation, the gesture may be simply described using the direction (L/R/U/D) and finger count (0, 2, 3, 4, 5). For example, L1 is an interpretation of one unfurled finger detected for the hand moving from right to left and may be interpreted as the number “1,” according to the table.

Table 1 shows an exemplary definition for a gesture system. The detected gesture may be compared against the interpretation scheme defined below, in Table 1 or Table 2, to determine the user command. However, the definition for the gesture system may be defined in various different ways without departing from the scope of the invention. Furthermore, more complex user commands may be formed by using the initial gesture definitions as building blocks. In one embodiment, a dictionary of symbols using macros may be generated and may be similar to shortcuts in the phone books, further economizing the use of gestures.

TABLE 1
An example of a simple semantics derived from the
gestures using direction and finger counting.

| | Gesture | Finger | | |
|---|---|---|---|---|
| # | Direction | Count | Interpretation | Comments |
| 1 | L | 0 | 0 | |
| 2 | R | 0 | DELETE LAST | |
| | | | SYMBOL | |
| 3 | L | 1 | 1 | |
| 4 | R | 1 | 6 | [R] = [L] + 5 |
| 6 | L | 2 | 2 | |
| 7 | R | 2 | 7 | |
| 8 | L | 3 | 3 | |
| 9 | R | 3 | 8 | |
| 10 | L | 4 | 4 | |
| 11 | R | 4 | 9 | |
| 12 | L | 5 | 5 | |
| 13 | R | 5 | 0 | |
| 14 | U | 0 | Beginning of Macro | |
| 15 | D | 0 | End of Macro | |
| 16 | U | 1 | Start Phone | |
| 17 | D | 1 | End Phone | |
| 18 | U | 2 | Start camera | Camera may use its |
| | | | | set of <L, R> |
| | | | | semantics |
| 19 | D | 2 | End camera | |
| 20 | U | 3 | Start loud speaker | |
| 21 | D | 3 | End loud speaker | |
| 22 | U | 4 | Start GPS | GPS may use its set |
| | | | | of <L, R> semantics |
| 23 | D | 4 | End GPS | |
| 24 | U | 5 | Show Options | Options may use its |
| | | | | set of <L, R> |
| | | | | semantics |
| 25 | D | 5 | Close Options | |

Several extensions to the above described definition may be possible, without departing from the scope of the invention. For example, the definition may be extended by forming a formal language, as illustrated in Table 2. The example grammar in Table 2 is an extension of the semantics described in Table 1. Table 2 depicts an exemplary illustration of simple Backus Normal Form (BNF) grammar used to generate Table 1. Grammar allows building new sequences of action using the basic constructs, enabling faster adoption and also allows the use of standard language development tools that are readily available to the users. Once grammar is generated all recognizers may be automatically generated. Formal definitions allows for a system to complete sequences, offering interactive help and in general enriching the human interface experience. Table 2 describes a system that defines a list of macros that may be used to execute an application. For example, dialing a phone can be an application #2, but there may be many macros corresponding to quick dialing of different yet often used numbers.

TABLE 2
Grammar Example for a simple individualized gesture language

| # | Rule | Comments |
|---|---|---|
| 1. | finger :== 1 \| 2 \| 3 \| 4 \| 5 | |
| 2. | hand := palm \| fist | |
| 3. | direction :== L \| R \| U \| D | |
| 4. | SPACE := L <hand> | |
| 5. | ERASE := R <hand> | |
| 6. | BEGIN := U <hand> | |
| 7. | END := D <hand> | |
| 8. | TOKEN := direction finger | |
| 9. | DIGIT := L \| R <finger> | |
| 10. | NUMBER := <DIGIT> \| <NUMBER> | |
| 11. | SHOW OPTIONS := U 5 | |
| 12. | CLOSE OPTIONS := D 5 | |
| 13. | YES := U 4 | |
| 14. | NO := D 4 | |
| 15. | CONFIRM := U 3 | |
| 16. | RUNTIME_OPTIONS := D 3 | Requests a |
| | | hints from the |
| | | system |
| 17. | RESPONSE := YES \| NO | |
| 18. | RUN := U 2 | |
| 19. | SELECT := D 2 | |
| 20. | MOVE_UP := U 1 | |
| 21. | MOVE_DOWN := D 1 | |
| 22. | MOVE := MOVE_UP \| MOVE_DOWN | |
| 23. | ARGUMENT := <NUMBER> SPACE | |
| 24. | <LOCATORS > := <MOVE> \| <LOCATORS> | |
| 25. | <LOCATORS INDEX> := <LOCATORS> | Select from |
| | <SELECT> \| <LOCATORS_INDEX> | feedback list |
| 26. | <HELP> := <BEGIN> <LOCATORS_INDEX> | Uses system |
| | <END> | feedback info |
| 27. | ARGUMENTS := <ARGUMENT> \| <HELP> \| | |
| | <ARGUMENTS> | |
| 28. | FUNCTION_ID := <ARGUMENT> \| <HELP> | |
| 29. | DEFINE_APP := BEGIN < | Gets unique |
| | FUNCTION_ID><ARGUMENTS> END \| | invocation id |
| | BEGIN < | |
| | FUNCTION_ID> <ARGUMENTS> | |
| | <CONFIRM> | |
| | END | |
| 30. | | |
| 31. | POWER DOWN := END END END | |
| 32. | SYSTEM RESET :== BEGIN BEGIN BEGIN | |
| 33. | RUN MACRO :== RUN <FUNCTION_ID> RUN | |
| | <FUNCTION_ID> RESPONSE | |

FIG. 10 illustrates an exemplary computing device incorporating parts of the device employed in practicing embodiments of the invention. A computing device as illustrated in FIG. 10 may be incorporated as part of any computerized system, herein. For example, computing device 100 can represent some of the components of a mobile device. A mobile device may be any computing system 100 with one or more input sensory unit or input devices 1015 such as sensors 1050 and one or more input/output devices such as a display unit or a touch screen. Examples of a computing device 100 include, but are not limited to, video game consoles, tablets, smart phones, laptops, netbooks, or other portable devices. In one embodiment, FIG. 10 describes one or more components of the computing device described in FIG. 1 and components and modules described in FIG. 3. FIG. 10 provides a schematic illustration of one embodiment of a computing device 100 that can perform the methods provided by various other embodiments, as described herein, and/or can function as the host computing device, a remote kiosk/terminal, a point-of-sale device, a mobile device, a set-top box and/or a computing device. FIG. 10 is meant only to provide a generalized illustration of various components, any or all of which may be utilized as appropriate. FIG. 10, therefore, broadly illustrates how individual system elements may be implemented in a relatively separated or relatively more integrated manner

The computing device 100 is shown comprising hardware elements that can be electrically coupled via a bus 1005 (or may otherwise be in communication, as appropriate). The hardware elements may include one or more processors 1010, including without limitation one or more general-purpose processors and/or one or more special-purpose processors (such as digital signal processing chips, graphics acceleration processors, and/or the like); one or more input devices 1015, which can include without limitation a camera, sensors 1050 (including photo detectors), a mouse, a keyboard and/or the like; and one or more output devices 1020, which can include without limitation a display unit such as the device display (110) of FIG. 1, a printer and/or the like. In one embodiment, the computing device 100 may also comprise analog sensors for processing information in the analog domain. Some of these sensors may be event-driven sensors.

The computing device 100 may further include (and/or be in communication with) one or more non-transitory storage devices 1025, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computing device 100 might also include a communications subsystem 1030, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 1030 may permit data to be exchanged with a network (such as the network described below, to name one example), other computing devices, and/or any other devices described herein. In many embodiments, the computing device 100 will further comprise a non-transitory working memory 1035, which can include a RAM or ROM device, as described above. The working memory 1035, may be used for accumulating information about the gesture before a user command may be interpreted, as discussed in FIG. 3, FIG. 7 and other figures of the specification.

The computing device 100 also can comprise software elements, shown as being currently located within the working memory 1035, including an operating system 1040, device drivers, executable libraries, and/or other code, such as one or more application programs 1045, which may comprise computer programs provided by various embodiments, and/or may be designed to implement methods, and/or configure systems, provided by other embodiments, as described herein. In one implementation, components or modules of FIG. 3 may be performed using such software elements. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1025 described above. In some cases, the storage medium might be incorporated within a computing device, such as computing device 1000. In other embodiments, the storage medium might be separate from a computing device (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computing device 100 and/or might take the form of source and/or installable code, which, upon compilation and/or installation on the computing device 100 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices 100 such as network input/output devices may be employed.

Some embodiments may employ a computing device (such as the computing device 100) to perform methods in accordance with the disclosure. For example, some or all of the procedures of the described methods may be performed by the computing device 100 in response to processor 1010 executing one or more sequences of one or more instructions (which might be incorporated into the operating system 1040 and/or other code, such as an application program 1045) contained in the working memory 1035. Such instructions may be read into the working memory 1035 from another computer-readable medium, such as one or more of the storage device(s) 1025. Merely by way of example, execution of the sequences of instructions contained in the working memory 1035 might cause the processor(s) 1010 to perform one or more procedures of the methods described herein.

The terms “machine-readable medium” and “computer-readable medium,” as used herein, refer to any medium that participates in providing data that causes a machine to operate in a specific fashion. In an embodiment implemented using the computing device 100, various computer-readable media might be involved in providing instructions/code to processor(s) 1010 for execution and/or might be used to store and/or carry such instructions/code (e.g., as signals). In many implementations, a computer-readable medium is a physical and/or tangible storage medium. Such a medium may take many forms, including, but not limited to, non-volatile media, volatile media, and transmission media. Non-volatile media include, for example, optical and/or magnetic disks, such as the storage device(s) 1025. Volatile media include, without limitation, dynamic memory, such as the working memory 1035. Transmission media include, without limitation, coaxial cables, copper wire and fiber optics, including the wires that comprise the bus 1005, as well as the various components of the communications subsystem 1030 (and/or the media by which the communications subsystem 1030 provides communication with other devices). Hence, transmission media can also take the form of waves (including without limitation radio, acoustic and/or light waves, such as those generated during radio-wave and infrared data communications). In an alternate embodiment, event-driven components and devices, such as cameras, may be used, where some of the processing may be performed in analog domain.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computing device 100. These signals, which might be in the form of electromagnetic signals, acoustic signals, optical signals and/or the like, are all examples of carrier waves on which instructions can be encoded, in accordance with various embodiments of the invention.

The communications subsystem 1030 (and/or components thereof) generally will receive the signals, and the bus 1005 then might carry the signals (and/or the data, instructions, etc. carried by the signals) to the working memory 1035, from which the processor(s) 1010 retrieves and executes the instructions. The instructions received by the working memory 1035 may optionally be stored on a non-transitory storage device 1025 either before or after execution by the processor(s) 1010.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method for determining a user hand gesture, comprising:
determining if a hand is within a detectable region of a field of view of a detection surface coupled to a computing device;
detecting a sequence of one or more hand features associated with the hand;
detecting a direction of movement of the hand; and
determining the user hand gesture based on the detected sequence of one or more hand features and the direction of the movement of the hand.

2. The method of claim 1, wherein the determining of the user hand gesture begins when the hand enters the detectable region of the field of view and the determining of the user hand gesture completes when the hand exits the detectable region of the field of view.

3. The method of claim 1, wherein the detectable region of the field of view is a near field mode.

4. The method of claim 3, wherein the near field mode comprises a region starting from the detection surface coupled to the computing device and extending outward to between one half of diagonal length of the detection surface to a full diagonal length of the detection surface.

5. The method of claim 1, wherein detecting the sequence of one or more hand features further comprises accumulating information associated with the one or more hand features as the hand moves across the field of view of the detection surface.

6. The method of claim 5, wherein the one or more hand features are fingers or finger tips and accumulating the information associated with the one or more hand features comprises counting a total number of unfurled fingers or finger tips.

7. The method of claim 1, wherein detecting the direction of the movement of the hand is one of left to right, right to left, top to bottom, bottom to top, away from the detection surface and towards the detection surface.

8. The method of claim 1, wherein detecting the direction of the movement of the hand further comprises:
using an electro-optic technology to measure and interpret intensity of light that is bended by a transparent panel using one or more light detectors to measure the intensity of light incident on the detection surface, wherein the transparent panel is part of the detection surface.

9. The method of claim 1, wherein detecting the sequence of one or more hand features further comprises:
using an electro-optic technology to measure and interpret intensity of light that is bended by a transparent panel using one or more light detectors to measure the intensity of light incident on the detection surface, wherein the transparent panel is part of the detection surface.

10. The method of claim 1, wherein the one or more hand features are detected using one of capacitive sensors and ultrasound proximity sensors.

11. The method of claim 1, wherein detecting the sequence of one or more hand features is based on detecting characteristics of the hand from shadows casting from the hand on to the detection surface.

12. The method of claim 1, wherein detecting the sequence of one or more hand features is based on detecting characteristics of the hand by emitting light from the computing device and away from the detection surface and detecting reflected back light from the hand onto the detection surface.

13. The method of claim 1, further comprising determining a user command using the determined user hand gesture.

14. The method of claim 13, further comprising providing visual and/or auditory feedback to a user in response to determining the user command.

15. A computing device for detecting a user hand gesture, comprising:
a plurality of sensors configured to receive light signals;
a processor configured to;
determine if a hand is within a detectable region of a field of view of a detection surface coupled to the computing device;
detect a sequence of one or more hand features associated with the hand;
detect a direction of movement of the hand; and
determine the user hand gesture based on the detected sequence of one or more hand features and the direction of the movement of the hand.

16. The computing device of claim 15, wherein the determination of the user hand gesture, by the processor, begins when the hand enters the detectable region of the field of view and the determining of the user hand gesture completes when the hand exits the detectable region of the field of view.

17. The computing device of claim 15, wherein the detectable region of the field of view is a near field mode.

18. The computing device of claim 17, wherein the near field mode comprises a region starting from the detection surface coupled to the computing device and extending outward to between one half of diagonal length of the detection surface to a full diagonal length of the detection surface.

19. The computing device of claim 15, wherein detecting the sequence of one or more hand features, by the processor, further comprises accumulating information associated with the one or more hand features as the hand moves across the field of view of the detection surface.

20. The computing device of claim 19, wherein the one or more hand features are fingers or finger tips and accumulating the information associated with the one or more hand features comprises counting a total number of unfurled fingers or finger tips.

21. The computing device of claim 15, wherein detecting the direction of the movement of the hand, by the processor, is one of left to right, right to left, top to bottom, bottom to top, away from the detection surface and towards the detection surface.

22. The computing device of claim 15, wherein detecting the direction of the movement of the hand, by the processor, further comprises:
using an electro-optic technology to measure and interpret intensity of light that is bended by a transparent panel using one or more light detectors to measure the intensity of light incident on the detection surface, wherein the transparent panel is part of the detection surface.

23. The computing device of claim 15, wherein detecting the sequence of one or more hand features, by the processor, further comprises:
using an electro-optic technology to measure and interpret intensity of light that is bended by a transparent panel using one or more light detectors to measure the intensity of light incident on the detection surface, wherein the transparent panel is part of the detection surface.

24. The computing device of claim 15, wherein the one or more hand features are detected, by the processor, using one of capacitive sensors and ultrasound proximity sensors.

25. The computing device of claim 15, wherein detecting the sequence of one or more hand features, by the processor, is based on detecting characteristics of the hand from shadows casting from the hand on to the detection surface.

26. The computing device of claim 15, wherein detecting the sequence of one or more hand features is based on detecting characteristics of the hand by emitting light from the computing device and away from the detection surface and detecting reflected back light from the hand onto the detection surface.

27. The computing device of claim 15, wherein the processor is further configured to determine a user command using the determined user hand gesture.

28. The computing device of claim 27, wherein the processor is further configured to provide visual and/or auditory feedback to a user in response to determining the user command.

29. A non-transitory computer readable storage medium, wherein the non-transitory computer readable storage medium comprises instructions executable by a processor, the instructions comprising instructions to:
determine if a hand is within a detectable region of a field of view of a detection surface coupled to a computing device;
detect a sequence of one or more hand features associated with the hand;
detect a direction of movement of the hand; and
determine a user hand gesture based on the detected sequence of one or more hand features and the direction of the movement of the hand.

30. The non-transitory computer readable storage medium of claim 29, wherein detecting the sequence of one or more hand features further comprises accumulating information associated with the one or more hand features as the hand moves across the field of view of the detection surface.

31. The non-transitory computer readable storage medium of claim 30, wherein the one or more hand features are fingers or finger tips and accumulating the information associated with the one or more hand features comprises counting a total number of unfurled fingers or finger tips.

32. The non-transitory computer readable storage medium of claim 29, wherein detecting the sequence of one or more hand features further comprises:
using an electro-optic technology to measure and interpret intensity of light that is bended by a transparent panel using one or more light detectors to measure the intensity of light incident on the detection surface, wherein the transparent panel is part of the detection surface.

33. An apparatus, comprising:
means for determining if a hand is within a detectable region of a field of view of a detection surface coupled to a computing device;
means for detecting a sequence of one or more hand features associated with the hand;
means for detecting a direction of movement of the hand; and
means for determining the user hand gesture based on the detected sequence of one or more hand features and the direction of the movement of the hand.

34. The apparatus of claim 33, wherein detecting the sequence of one or more hand features further comprises means for accumulating information associated with the one or more hand features as the hand moves across the field of view of the detection surface.

35. The apparatus of claim 33, wherein detecting the sequence of one or more hand features further comprises:
using an electro-optic technology to measure and interpret intensity of light that is bended by a transparent panel using one or more light detectors to measure the intensity of light incident on the detection surface, wherein the transparent panel is part of the detection surface.
